(19) United States
(12) Patent Application Publication
(10) Pub. No.: US 2006/0097083 A1
(43) Pub. Date: May 11, 2006

(54) Coinjection nozzle

(76) Inventors: Otto Hofstetter, Uznach (CH); Luis Fernandez, Uznach (CH)

Correspondence Address: NATH & ASSOCIATES, 112 South West Street, Alexandria, VA, 22314, US

(21) Appl. No.: 10/543,391

(22) PCT Filed: Jan. 30, 2004
(86) PCT No.: PCT/CH04/00050

§ 371 Date: Jul. 26, 2005

(30) Foreign Application Priority Data
Jan. 31, 2003 (CH) 142/03

(51) Int. Cl. F02M 51/00; A62C 31/02; B05B 1/14; B05B 1/30

(52) U.S. Cl. 239/585.5; 239/589; 239/590.5

(57) ABSTRACT

Disclosed is a coinjection nozzle for a two-component injection molding tool, which is used for producing parisons. The inventive nozzle comprises a nozzle holder (1) and an nozzle tip (4) that is mounted therein. A shut-off needle (11) is directed within a needle guide (3) at least in a top portion (K) of the needle tip (4). An additional nozzle sleeve (2) is disposed between the needle guide (3) and the nozzle tip (4). A first tubular delivery duct (A) extends between the nozzle sleeve (2) and the nozzle tip (4) while a second tubular delivery duct (B) extends between the nozzle sleeve (2) and the needle guide (3). The needle guide (3) is provided with a conical needle-guiding head (3a) located in the top portion (K) of the nozzle. A throat is provided in the first tubular delivery duct (A) in the area (E) of the nozzle. The needle-guiding head (3a) and the nozzle sleeve (2) are shaped in such a way that the second tubular delivery duct (B) narrows in a final area so as to form a shear edge (F).

### BACKGROUND OF THE INVENTION

The present invention concerns a coinjection nozzle for a two-component injection molding tool according to the preamble of claim 1.

Such coinjection nozzles are used in injection molding tools such as are used in the manufacture of multilayer preforms, in particular preforms suitable for blow-stretching made of PET and having a barrier layer made of Nylon®.

A device with which such multilayer preforms can be manufactured is described, for example, in DE 35 19 921. Therein, a hot channel nozzle for blow-molding a multilayer body made of two components is described. This hot channel nozzle comprises two concentrically arranged heated sprue channels for supplying a first material for the first sprue channel and a second material for the second sprue channel. In the inner channel there is a pin or nozzle needle which can be moved back and forth pneumatically. This needle regulates the injection of the two components. With this nozzle, one component of the synthetic is guided inside the nozzle along the needle. With this type of nozzle it has been shown that the molten synthetic material, and in particular the thinner or less viscous component creeps between the nozzle needle and the needle guide in the hot runner block and the pneumatic mechanism and sets there. The disadvantage of this, is that material which sets there also decomposes. Thus for example, if PET becomes set, then acetaldehyde is produced which leads to an unacceptable impairment of taste, especially in drinks and other foodstuffs. Furthermore, material which has become set it the regions mentioned impairs the movement of the needle, in extreme cases completely immobilising the needle. Depending upon the actual position of the blocked needle, the result can be that no material at all can escape or that material leaks out constantly. If material constantly leaks out, then this leads to an undesired formation of strands on the one hand, and to a contamination of the form plates on the other hand, which makes necessary a time-intensive cleaning procedure. Also it is obvious that in the case of tools for the simultaneous manufacture of 48, 96 or more preforms, such damaged nozzles are difficult to locate in the tool and to repair.

All in all, this type of nozzle requires intensive maintenance. To avoid leakages during the injection process it is necessary to work at a relatively low conveyor pressure, which has a direct effect on the number of preforms manufactured per time unit and thus on the profitability of the tool. This nozzle also has the disadvantage that the two components become mixed or blended in the nozzle tip, which is unacceptable, especially in the manufacture of preforms for the beverage industry.

A further device for the manufacture of such multilayer preforms is described in EP 0 647 514. This patent discloses a multi-plate injection molding tool with multiple cavities, which is constructed of mutually displaceable plates and comprises a hot channel distribution block. The hot channel nozzles are equipped with pneumatic nozzle closure arrangements for releasing or shutting off the individual components. Also with this hot channel nozzle one component of the synthetic material is fed inside the nozzle along the needle. In order to avoid that molten synthetic material creeps between the nozzle needle and the needle guide into the hot runner block and the pneumatic device and sets there, a gas-tight axial seal made of temperature resistant synthetic material is arranged in the nozzle holder. This seal permits working at a conveyor pressure of 900 to 1000 bar, which is a substantial improvement on the nozzle described previously. However, also with this type of nozzle it has become evident that leakages between the nozzle needle and the needle guide cannot be eliminated completely, so that also here the material decomposes. As already stated, this disadvantage is unacceptable in the beverage industry. Furthermore, this needle also has the disadvantage that the two components admix in the needle tip. It is a further disadvantage that the rubber seals must be replaced at regular intervals due to the fact that they are permanently exposed to the hot material or the vapours of the individual hot material components, which results in them becoming brittle and no longer sealing over a period of time. If there are 48, 96 or more nozzles, the replacement of the rubber seals is very time consuming.

### SUMMARY OF THE INVENTION

It is therefore the object of the present invention to provide a low maintenance coinjection nozzle for a two-component injection molding tool without the disadvantages mentioned previously. In particular, the injection molding tool should allow working at conveyor pressures of more than 1000 bar without leakages occurring between the nozzle needle and the needle guide. Furthermore, the tool should be low maintenance and should prevent an admixing of the two components in the needle tip.

According to the invention this object is achieved by a coinjection nozzle having the features of claim 1, and in particular by a needle guide being provided as far as the top or head of the nozzle and neither of the two components being guided along the needle. According to the invention a nozzle sleeve or sheath is arranged between the needle guide and the nozzle tip in such a manner that between the nozzle sheath and the nozzle tip a first tubular conveying duct or channel for an A-component is provided on the one hand, and between the nozzle sheath and the needle guide a second tubular conveying duct or channel for a B-component is provided on the other hand.

In a preferred embodiment, in the top or head portion of the nozzle the needle guide comprises a conically shaped needle guide head and the nozzle sheath extends up to this needle guide head.

A further development of the inventive nozzle provides for the nozzle sheath being widened or enlarged at its end facing towards the needle guide head, and thus forming a stricture which acts as a shearing edge of the first tubular conveying channel. This stricture enables an alignment or focussing of the flow front of the material in the first conveying channel. In a further embodiment, the needle guide head and the nozzle sheath are formed in such manner that the second tubular conveying channel is locally constricted so as to form a shearing edge.

In another preferred embodiment, a simple pneumatic piston arrangement is used for controlling the nozzle needle. This simple piston arrangement considerably simplifies controlling the needle movements, in particular during simultaneous production of 48 or 96 preforms.

Further preferred embodiments exhibit the features of the dependent claims. The advantages of the coinjection nozzle according to the present invention are immediately apparent to the expert. Due to the fact that the needle guide is not also a conveying channel for a material component, leakages can be precluded. This prevents a material component from creeping into the hot runner block and setting there which, in turn, prevents component material from decomposing. Thus, a conveyor pressure of more than 1000 bar can be used, which significantly increases the profitability of the tools equipped with the nozzles according to the invention. Furthermore, admixing of the two components is precluded. Because leakages are eliminated and because there is no need for particular types of seals or gaskets, the nozzle according to the present invention is extremely low in maintenance. This type of conveyor channel path allows the use of a simple pneumatic piston arrangement for operating the needle, because here the needle must only be moved between two positions or settings (open/closed), whereas in prior art nozzles the needle must be moved-between at least three positions.

The invention shall be more closely described by means of embodiments and with the aid of the drawings.

### BRIEF DESCRIPTION OF THE DRAWINGS

FIG. 1 shows a spatial view of a two-component coinjection nozzle;

FIG. 2 shows a longitudinal section through a two-component coinjection nozzle according to the invention, along the line Y-Y of FIG. 1;

FIG. 3 shows a longitudinal section through a two-component coinjection nozzle according to the invention along the line X-X of FIG. 1; and

FIG. 4 shows an enlarged view of the region towards the opening of the nozzle according to FIG. 2.

### DETAILED DESCRIPTION OF THE PREFERRED EMBODIMENTS

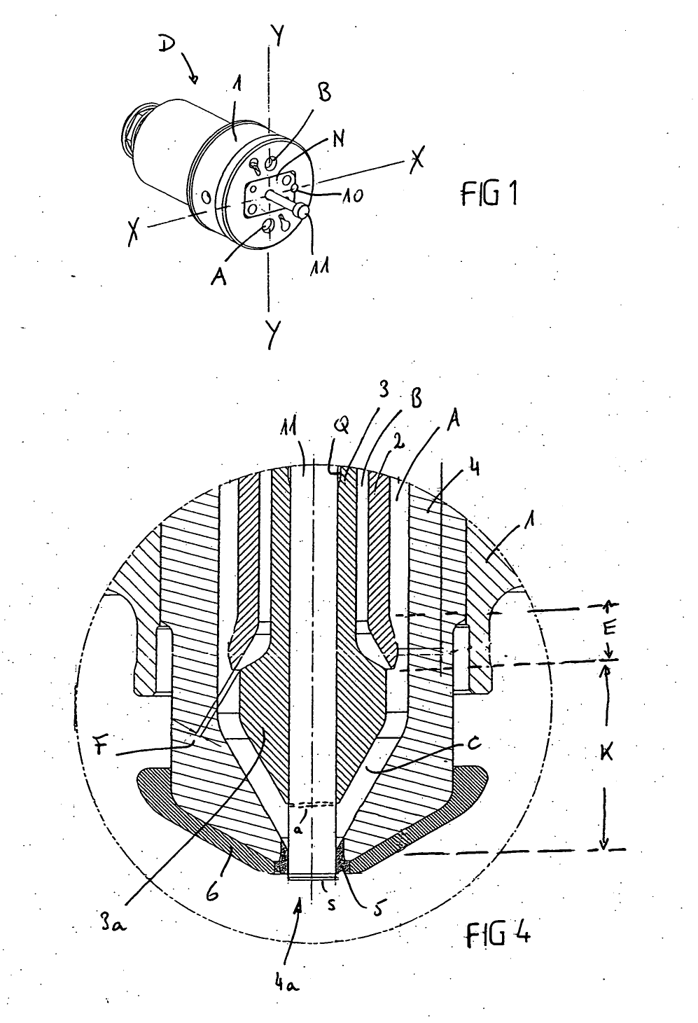

FIG. 1 shows a spatial view of an inventive coinjection nozzle D having a first supply opening for supplying an A-component and a second supply opening for supplying a B-component. In this embodiment, a needle guide base N is formed as a square plate in order to prevent the needle guide from rotating. This needle guide base N is secured to a nozzle holder 1 with the aid of a cylindrical pin 10 and serves to reliably guide the nozzle needle 11 within the nozzle D.

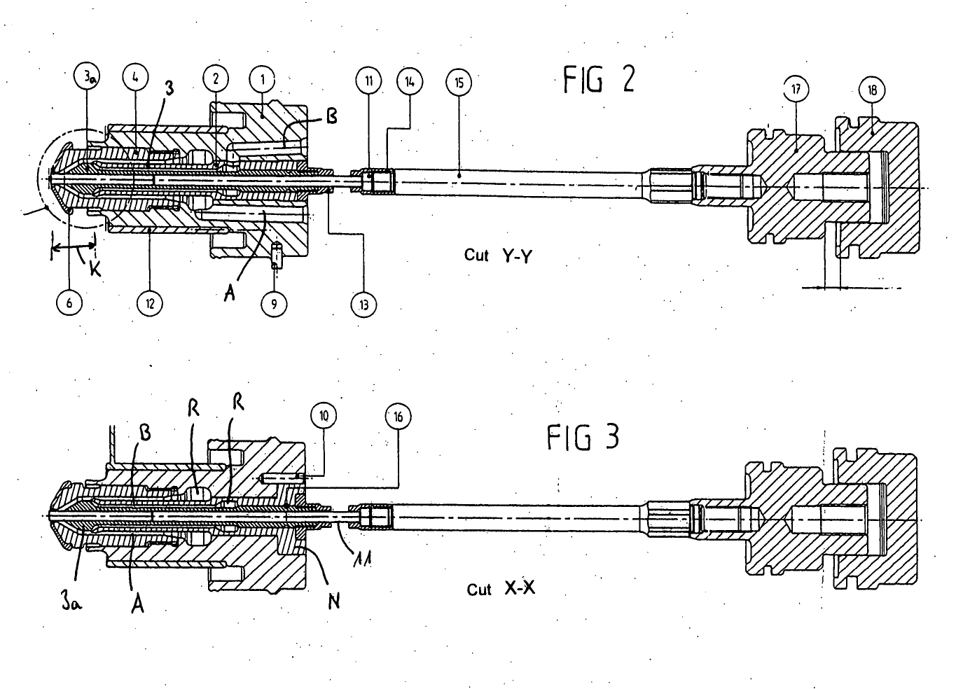

A preferred embodiment of the inventive nozzle is shown in FIG. 2. This nozzle comprises a nozzle holder 1 which is secured in the base plate by means of a cylindrical pin 9. Two supply ducts are positioned in this nozzle holder 1, a first supply duct A for an A-component and a second supply duct B for a B-component. At the discharge side of the nozzle holder 1 a nozzle tip 4 is screwed into the nozzle holder 1. A nozzle sleeve or sheath 2 is secured in the nozzle holder 1 at the base plate side. This nozzle sheath 2 protrudes into the interior of the nozzle tip 4 and, together with the nozzle tip 4 forms a first tubular supply duct A for conveying an A-component. This A-component is generally PET-material having a temperature of around 280° C.-300° C. Inside the nozzle sheath 2 a nozzle guide 3 is arranged in such a manner, that between this nozzle guide 3 and the nozzle sheath 2 there is formed a second tubular supply duct B for conveying the B-component, i.e. the supply ducts are arranged concentrically around the needle guide. This B-component is generally any type of barrier material, such as, for example Nylon®, which has a temperature of around 260° C. This nozzle guide protrudes into the top portion K of the nozzle and in this portion comprises a conically shaped needle guide head 3a. The nozzle guide 3 guides the nozzle needle 11 from the needle guide base N to the needle guide head 3a in a tight fitting manner. In a known manner the nozzle holder 1 is provided with a ring-shaped or circular heater 12 in the region of the nozzle tip 4. The nozzle needle 11 is connected to a piston elongation 15 by means of a needle fastener 14. This piston elongation 15 is secured to a piston 17 which is slidingly mounted in a cylinder 18.

FIG. 3 shows a longitudinal section along the line X-X in FIG. 1 through the coinjection nozzle according to the invention. In the configuration shown, the needle 11 is in a closed position s, i.e. it closes the discharge opening 4a of the nozzle. In order to fill a form cavity (not shown), the needle 11 is pulled back into an operating position a with the aid of the pneumatic drive and, at the same time, the A-component, preferably PET, is pressed through the supply duct A in order to fill a first part of the form cavity. In a second step, the B-component is conveyed through the supply duct B. This B-component is generally a type of thin flowing barrier material, such as, for example, Nylon®. Due to the lower viscosity of this B-component, it flows within the more viscous A-component already in the top or head portion K of the nozzle and therefore does not come into contact with the nozzle needle 11. This makes it evident that this thin flowing B-component cannot creep in-between the nozzle needle 11 and the nozzle guide 3. In a next step the nozzle needle 11 is brought back into its closed position s to conclude the injection molding operation. Thus, the special construction of the nozzle according to the invention also simplifies the movement control of the needle 11 in that only one closed position s and one open or operating position a are needed.

FIG. 4 shows a geometric arrangement of a preferred embodiment of the region towards the opening of the inventive nozzle in detail. The nozzle tip 4 is inserted into the nozzle holder 1 and, at its discharge opening 4a comprises a heat protection cap 6 and a nozzle insert 5. This heat protection cap 6 serves to thermally insulate against the cold form cavity. The interior space C of the nozzle tip 4 tapers off conically towards the discharge opening 4a to enable a laminate flow behaviour of the components to be injected. The nozzle needle 11 is tightly fitted in the needle guide 3 and can be moved between a closed position s and an operating position a. The nozzle sheath 2 is arranged between the needle guide 3 and the nozzle tip 4 in such a manner that, on the one hand, a first tubular supply duct A is formed between the nozzle sheath 2 and the nozzle tip 4, and on the other hand, a second tubular supply duct B is formed between the nozzle sheath 2 and the needle guide 3. In the top portion K of the nozzle the needle guide 3 comprises a conically shaped needle guide head 3a. In the embodiment shown, the nozzle sheath 2 is enlarged in a region E behind the needle guide head 3a and thereby creates a stricture in the supply duct A which acts as a shear edge, and which essentially results in a straightening of the flow front of the A-component.

Further developments are within the normal scope of the expert and are to be seen in particular in the special design or shaping of the supply ducts A, B. It is to be understood that the dimensions of the individual elements are dependent upon the material used and that the expert may provide further shear edges in the supply duct. Furthermore, the needle guide can have transverse grooves Q on the side towards the needle. Also, catchment grooves can be provided in the nozzle holder and in the nozzle sheath.

1. A coinjection nozzle for a two-component injection molding tool for producing preforms, comprising a nozzle holder (1) and a nozzle tip (4) mounted therein, in which nozzle tip (4) there is arranged a needle (11) in such a manner that a tubular space is formed between the needle (11) and the nozzle tip (4), whereby the needle (11) is provided in at least one top region (K) of the nozzle tip (4) with a needle guide (3), characterized in that between the needle guide (3) and the nozzle tip (4) there is arranged a nozzle sheath (2) in such a manner that, on the one hand, between the nozzle sheath (2) and the nozzle tip (4) there is a tubular supply duct (A) and, on the other hand, between the nozzle sheath (2) and the needle guide (3) there is a second supply duct (B).

2. Coinjection nozzle according to claim 1, characterized in that the nozzle sheath (2) extends to behind the top portion (K) of the nozzle.

3. Coinjection nozzle according to one of claims 1 or 2, characterized in that the needle guide (3) comprises a conically shaped needle guide head (3a) in the top portion (K) of the nozzle.

4. Coinjection nozzle according to claim 3, characterized in that the nozzle sheath (2) extends to behind the needle guide head (3a).

5. Coinjection nozzle according to claim 4, characterized in that the needle guide (3) is enlarged in a region (E) behind the needle guide head (3a) and thus creates a stricture in the first tubular supply duct (A).

6. Coinjection nozzle according to claim 2, characterized in that the needle guide head (3a) and the nozzle sheath (2) are formed such that the second tubular supply duct (B) is strictured in a region (E) behind the needle guide head (3a) and forms a shear edge (F).

7. Coinjection nozzle according to claim 1, characterized in that the nozzle needle (11) is tightly fitted in the needle guide (3).

8. Coinjection nozzle according to claim 7, characterized in that the needle guide (3) comprises transverse grooves (Q) on the side towards the needle.

9. Coinjection nozzle according to claim 7, characterized in that in the nozzle guide (1) and in the nozzle sheath (2) catchment grooves (R) are provided.

10. Coinjection nozzle according to claim 1, characterized in that the nozzle needle (11) is movable into a closed and into an operating position by means of a simple pneumatic piston arrangement.
